(19) United States
(12) Patent Application Publication
(10) Pub. No.: US 2018/0200659 A1
(43) Pub. Date: Jul. 19, 2018

(54) FILTER DEVICE AND BATTERY COOLING APPARATUS

(71) Applicant: TOYOTA JIDOSHA KABUSHIKI KAISHA, Toyota-shi (JP)

(72) Inventor: Tsuyoshi HAYASHI, Miyoshi-shi (JP)

(73) Assignee: TOYOTA JIDOSHA KABUSHIKI KAISHA, Toyota-shi (JP)

(21) Appl. No.: 15/867,040

(22) Filed: Jan. 10, 2018

(30) Foreign Application Priority Data
Jan. 17, 2017 (JP) 2017-005680

(51) Int. Cl. B01D 46/52; B01D 46/00; H01M 10/613; H01M 10/625; H01M 10/6563

(52) U.S. Cl. CPC B01D 46/523; B01D 46/0005; H01M 10/613; H01G 11/18; H01M 10/6563; H01M 2220/20; H01M 10/625

(57) ABSTRACT

A filter device includes a filter body and a bezel. The filter body is folded in pleats, and includes top sections and bottom sections that are alternately aligned. The top sections are disposed at an upstream end of the filter body in a flow direction of gas that passes through the filter body. The bezel is configured to support the filter body. The bezel includes a fin provided upstream of the filter body in the flow direction of the gas. The fin and the top section are aligned with each other in the flow direction of the gas.

### CROSS-REFERENCE TO RELATED APPLICATIONS

The disclosure of Japanese Patent Application No. 2017-005680 filed on Jan. 17, 2017 including the specification, drawings and abstract is incorporated herein by reference in its entirety.

### BACKGROUND

### 1. Technical Field

The disclosure relates to a filter device and a battery cooling apparatus.

### 2. Description of Related Art

For example, Japanese Unexamined Patent Application Publication No. 2016-165949 (JP 2016-165949 A) describes a cooling duct device including: an inlet duct through which cooling air for cooling a battery module is guided to the battery module; a bezel provided in an inlet port of the inlet duct; and a filter provided on the back side of the bezel.

### SUMMARY

In the configuration described in JP 2016-165949 A, the filter includes a plurality of protrusions and recesses, and the bezel includes fins. If dust is accumulated between the filter and the fins, the efficiency of cooling the battery module is reduced.

The disclosure is made in the light of the foregoing circumstances, and the disclosure provides a filter device configured to reduce the accumulation of dust and also provides a battery cooling apparatus including the filter device.

An aspect of the disclosure relates to a filter device including a filter body and a bezel. The filter body is folded in pleats. The filter body includes top sections and bottom sections that are alternately aligned. The filter body has the top sections at an upstream end of the filter body in a flow direction of gas that passes through the filter body. The bezel is configured to support the filter body. The bezel includes a fin provided upstream of the filter body in the flow direction of the gas. The fin and the top section are aligned with each other in the flow direction of the gas.

In the filter device, the bezel may include a frame, a plurality of the fins, and a plurality of pillars. Further, the frame may include an upper frame, a lower frame, and two lateral frames. The two lateral frames respectively couple a first end portion of the upper frame and a second end portion of the upper frame to a first end portion of the lower frame and a second end portion of the lower frame. Further, the plurality of fins may be provided parallel to each other. Further, the plurality of pillars may be provided parallel to each other and couple the upper frame to the lower frame.

In the filter device, the upper frame, the lower frame, and the two lateral frames of the frame may form a parallelogram. The fins may intersect perpendicularly with the pillars within the frame. The pillars may extend in a direction perpendicular to an extending direction of the upper frame and the lower frame.

In the filter device, the top section may be fixed to a downstream end of the fin.

Another aspect of the disclosure relates to a battery cooling apparatus including: a battery; a duct configured to guide cooling gas to the battery; and the filter device according to the foregoing aspect. The filter device is attached to the duct. The filter device is configured such that the cooling gas passes through the filter device.

With the filter device and the battery cooling apparatus according to the foregoing aspects of the disclosure, accumulation of dust in the filter device can be efficiently reduced. When the filter device configured to reduce the accumulation of the dust is mounted in a battery cooling apparatus, reduction in the cooling efficiency of the battery cooling apparatus can be suppressed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view illustrating the configuration of a battery cooling apparatus according to an embodiment of the disclosure;

FIG. 2 is a perspective view of a filter device according to the embodiment, as viewed from the upstream side; and

FIG. 3 is a lateral sectional view of the filter device according to the embodiment.

### DETAILED DESCRIPTION OF EMBODIMENTS

Hereinafter, a filter device and a battery cooling apparatus according to an embodiment will be described with reference to the accompanying drawings. In the embodiment described below, the same or substantially the same elements will be denoted by the same reference symbols, and the description thereof will not be repeated.

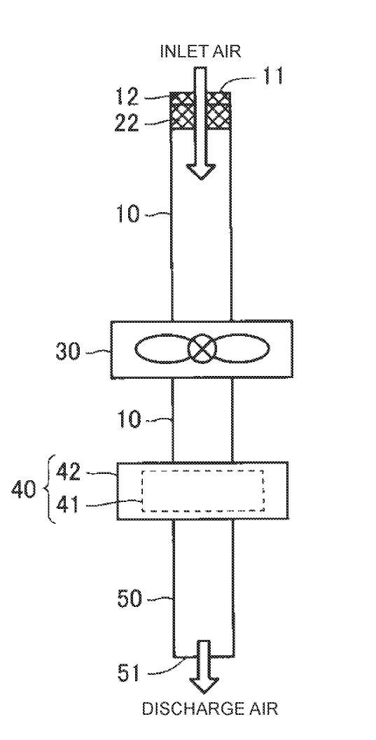

FIG. 1 is a schematic view illustrating the configuration of a battery cooling apparatus according to the embodiment. The battery cooling apparatus illustrated in FIG. 1 is mounted in a vehicle. In one example, the battery cooling apparatus is mounted in a hybrid vehicle including, as drive sources, an internal combustion engine, such as a gasoline engine or a diesel engine, and a motor driven by electric power supplied from a battery. In another example, the battery cooling apparatus is mounted in an electric vehicle or a fuel cell vehicle.

As illustrated in FIG. 1, the battery cooling apparatus configured to cool an assembled battery 41 mainly includes an inlet duct 10, a fan 30, a battery pack 40, and a discharge duct 50.

The inlet duct 10 includes an inlet port 11 into which air (an example of “gas”) for adjusting the temperature of the battery pack 40 is taken. The inlet port 11 is exposed to a vehicle cabin (corresponding to “the inside of the vehicle”), so that the air in the vehicle cabin is taken into the inlet port 11. The vehicle cabin is a space where occupants are seated. The temperature of the air in the vehicle cabin is adjusted by an air-conditioning system mounted in the vehicle.

The filter device is attached to the inlet port 11 of the inlet duct 10. The air that has been taken into the inlet port 11 passes through the filter device. The filter device is configured to reduce the entry of foreign matter into the inlet duct 10 from the inlet port 11.

The filter device includes a bezel 12 and a filter body 22. The bezel 12 is attached to the inlet duct 10. The filter body 22 has a mesh structure, and is used to remove dust (corresponding to “foreign matter”) from the air passing through the inlet duct 10. That is, the air that has entered the inlet duct 10 from the inlet port 11 passes through the filter device, whereas the dust that has entered the inlet duct 10 from the inlet port 11 is caught in the filter body 22. Examples of the dust include lint that falls from clothing.

The position at which the filter device is provided is not limited to the inlet port 11 illustrated in FIG. 1. As long as the dust is prevented from reaching the battery pack 40, the filter device may be provided at any position in the inlet duct 10. In order to prevent the dust from settling on the fan 30, the filter device is preferably provided at a position closer to the inlet port 11 than the fan 30 is (i.e., a position between the inlet port 11 and the fan 30).

The fan 30 is provided at an intermediate portion of the inlet duct 10. As the fan 30 turns, the air in the vehicle cabin is taken into the inlet duct 10 through the inlet port 11. The air that has been taken into the inlet duct 10 passes through the fan 30 and is then guided to the battery pack 40.

The battery pack 40 includes the assembled battery 41 and a case 42 that accommodates the assembled battery 41. The assembled battery 41 includes a plurality of cells. As each cell, a secondary cell, such as a nickel-metal-hydride cell or a lithium-ion cell, may be used. An electric double-layer capacitor may be used instead of a secondary cell. All the cells that constitute the assembled battery 41 may be electrically connected in series. Alternatively, a plurality of cells electrically connected in parallel may be included in the assembled battery 41.

The assembled battery 41 is used as a drive source for causing the vehicle to travel. More specifically, the electric energy output from the assembled battery 41 is converted, by a motor generator, into kinetic energy used to cause the vehicle to travel. That is, the kinetic energy produced by the motor generator is transmitted to wheels, so that the vehicle can travel.

On the other hand, while the vehicle is decelerating or is coming to a stop, the motor generator converts kinetic energy produced at the time of braking of the vehicle into electric energy, and then outputs the electric energy to the assembled battery 41. In this way, the assembled battery 41 is charged with regenerative electric power.

The temperature of the assembled battery 41 may increase due to charging and discharging, or under the influence of external environment. In this case, the fan 30 is driven to supply the air in the vehicle cabin to the assembled battery 41 through the inlet duct 10, so that an increase in the temperature of the assembled battery 41 can be suppressed. When the temperature of the assembled battery 41 increases, the temperature of the air in the vehicle cabin tends to be lower than the temperature of the assembled battery 41. Thus, the air in the vehicle cabin is supplied to the assembled battery 41, so that the assembled battery 41 comes in contact with the air supplied from the vehicle cabin. In this way, the assembled battery 41 can be cooled by heat exchange between the assembled battery 41 and the air supplied from the vehicle cabin.

The inlet duct 10 is connected to the case 42, and therefore the air that has passed through the inlet duct 10 moves into the case 42. The assembled battery 41 is accommodated in the case 42, and therefore the air that has moved into the case 42 comes in contact with the assembled battery 41. A path along which the air moves in the case 42 may be set as appropriate, as long as the air can be efficiently guided to each of the cells that constitute the assembled battery 41. The path along which the air moves in the case 42 may be set in consideration of an outer shape of each cell, such as a rectangular cell or a cylindrical cell.

The discharge duct 50 is connected to the case 42 of the battery pack 40. The air that has undergone the heat exchange with the assembled battery 41 in the case 42 moves to the discharge duct 50. The discharge duct 50 includes a discharge port 51, and the air that has moved to the discharge duct 50 is discharged from the discharge port 51. The air discharged from the discharge port 51 may be returned to the vehicle cabin or may be guided to a space (e.g., a luggage room) in the vehicle other than the vehicle cabin. Alternatively, the air discharged from the discharge port 51 may be guided to the outside of the vehicle.

In the configuration illustrated in FIG. 1, the fan 30 is provided in the inlet duct 10. However, the position of the fan 30 is not limited to this, as long as the air can be taken into the inlet duct 10 through the inlet port 11 as the fan 30 is driven. For example, when the fan 30 is provided in the discharge duct 50, the air can be taken into the inlet duct 10 through the inlet port 11 as the fan 30 is driven.

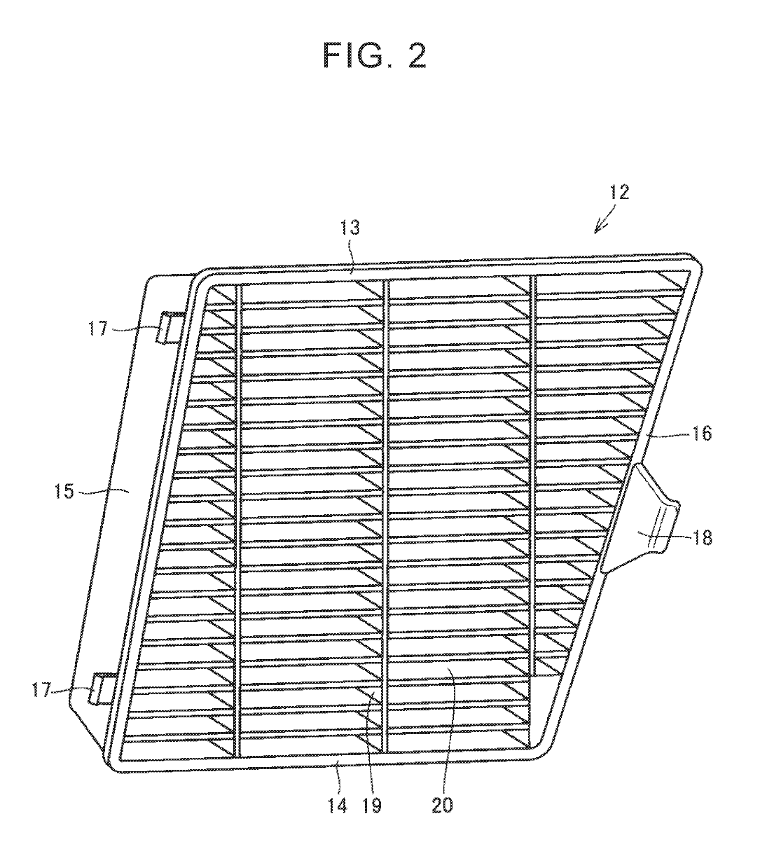

FIG. 2 is a perspective view of the filter device according to the embodiment, as viewed from the upstream side As illustrated in FIG. 2, when the filter device is viewed from the upstream side, the bezel 12 is visually recognized. The filter body 22 is provided downstream of the bezel 12 in a flow direction of the air. In FIG. 2, the filter body 22 is disposed behind the bezel 12, and therefore the filter body 22 is blocked by the bezel 12 and does not appear in FIG. 2.

As illustrated in FIG. 2, the bezel 12 includes an upper frame 13, a lower frame 14, and lateral frames 15, 16. The upper frame 13 and the lower frame 14 extend substantially parallel to each other. Each of the lateral frames 15, 16 extends in a direction tilted with respect to the upper frame 13 and the lower frame 14. The lateral frames 15, 16 couple a first end portion and a second end portion of the upper frame 13 to a first end portion and a second end portion of the lower frame 14, respectively. As viewed from the upstream side in the flow direction of the air that passes through the filter device, the bezel 12 has a generally parallelogram outer shape.

A pair of upper and lower hinges 17 is attached to the lateral frame 15. A handle 18 is attached to the lateral frame 16. As a worker holds the handle 18 with his/her finger(s) and pulls the handle 18 toward the worker, the bezel 12 can pivot about the hinges 17 serving as pivot points.

A plurality of (three, in the present embodiment as illustrated in FIG. 2) pillars 19 is provided to couple the upper frame 13 to the lower frame 14. The pillars 19, which are parallel to each other, extend in an up-down direction, that is, in a direction perpendicular to the extending direction of the upper frame 13 and the lower frame 14.

A plurality of fins 20 is provided between the pillars 19 that are adjacent to each other. The fins 20 extend parallel to the upper frame 13 and the lower frame 14. The fins 20 extend in a lateral direction, that is, in a direction perpendicular to the up-down direction.

The bezel 12 includes: a frame body constituted by the upper frame 13, the lower frame 14, and the lateral frames 15, 16; and the pillars 19 and the fins 20 that are perpendicular to the pillars 19 within the frame body. The bezel 12 has a lattice shape as a whole.

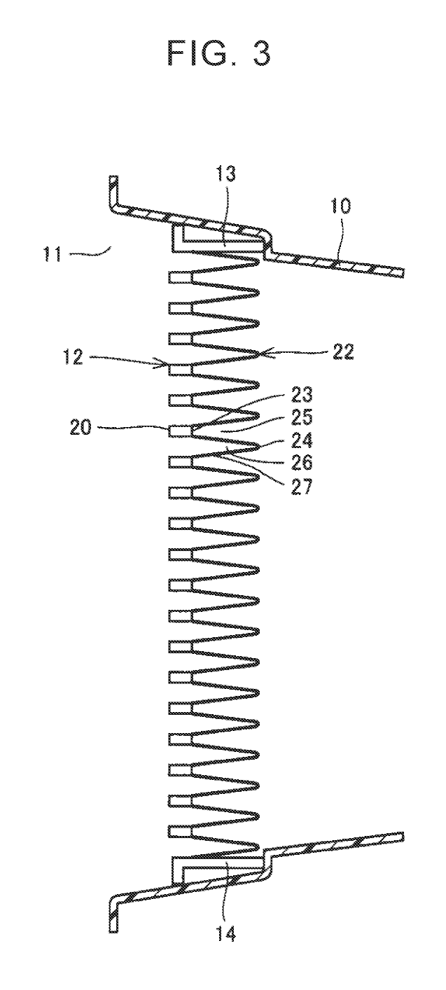

FIG. 3 is a lateral sectional view of the filter device according to the embodiment. In FIG. 3, a region on the left side of the filter device corresponds to the outside of the inlet duct 10, and a region on the right side of the filter device corresponds to the inside of the inlet duct 10. The lateral direction in FIG. 3 corresponds to the flow direction of the cooling air for cooling the assembled battery 41. The left side in the FIG. 3 corresponds to the upstream side in the flow direction of the air. The right side in the FIG. 3 corresponds to the downstream side in the flow direction of the air.

As illustrated in FIG. 3, the bezel 12 is accommodated in the inlet duct 10 and is provided near the inlet port 11. A worker can easily access the filter device through the inlet port 11. As described above, a worker causes the bezel 12 to pivot about the hinges 17 and then moves the bezel 12 toward the outside of the inlet duct 10, whereby the worker can easily perform maintenance of the filter body 22 provided inside the bezel 12. For example, a worker can easily perform cleaning for removing the dust caught in the filter body 22, and replacement of the filter body 22 that has been used so far with a new filter body 22.

The filter body 22 is accommodated in the bezel 12. One end (an upper end) of the filter body 22 in the up-down direction (the up-down direction in FIG. 3) is attached to the upper frame 13 of the bezel 12. The other end (a lower end) of the filter body 22 in the up-down direction is attached to the lower frame 14 of the bezel 12. The filter body 22 is surrounded by the upper frame 13, the lower frame 14, and the lateral frames 15, 16 of the bezel 12. The filter body 22 supported by the bezel 12 is accommodated in the inlet duct 10 and is provided near the inlet port 11.

The filter body 22 is folded in pleats. The filter body 22 is made of a filter material, such as a sheet-shaped mesh material, nonwoven fabric, or porous membrane. The filter body 22 is formed by performing mountain fold and valley fold alternately on the filter material so as to fold the filter material in a zigzag manner. Folds (i.e., folded parts) are aligned in the up-down direction. Each of the folds includes a mountain portion 25 and a valley portion 26. In the filter body 22 illustrated in FIG. 3, each mountain portion 25 protrudes toward the inlet port 11, which is the entrance to the inlet duct 10, that is, protrudes toward the upstream side in the flow direction of the air. One valley portion 26 is formed between two mountain portions 25 that are adjacent to each other. Each valley portion 26 protrudes in a direction away from the inlet port 11, that is, protrudes toward the downstream side in the flow direction of the air.

Each mountain portion 25 includes a top section 23. Each valley portion 26 includes a bottom section 24. The top sections 23 and the bottom sections 24 are folded parts of the filter body 22. In each mountain portion 25, the top section 23 is a section that protrudes, to the largest extent, toward the upstream side in the flow direction of the air. The top section 23 constitutes an upstream end of the mountain portion 25 in the flow direction of the air that passes through the filter body 22. The bottom section 24 constitutes a downstream end of the valley portion 26 in the flow direction of the air that passes through the filter body 22. The top sections 23 and the bottom sections 24 are alternately aligned in the up-down direction.

The filter body 22 includes a plurality of tilted surfaces 27 connecting the top sections 23 to the bottom sections 24. Two tilted surfaces 27 that are adjacent to each other and the top section 23 between the two tilted surfaces 27 constitute one mountain portion 25. Two tilted surfaces 27 that are adjacent to each other and the bottom section 24 between the two tilted surfaces 27 constitute one valley portion 26. The filter body 22 is folded in pleats such that the mountain portions 25 and the valley portions 26 are alternately aligned.

The fins 20 of the bezel 12 are provided upstream of the filter body 22 in the flow direction of the air that passes through the filter device (the lateral direction in FIG. 3). The fins 20 are aligned with the top sections 23 of the filter body 22 in the flow direction of the air. The top sections 23 of the filter body 22 are attached to downstream ends of the fins 20 in the flow direction of the air. The top sections 23 of the filter body 22 are fixed to the downstream ends of the fins 20. The filter body 22 and the bezel 12 are integral with each other, as a single-piece structure. The filter body 22 and the bezel 12 are integrally molded using a resin material.

The pillars 19, illustrated in FIG. 2 and extending in the direction perpendicular to the fins 20, are provided so as to extend into the valley portions 26 of the filter body 22. The pillars 19 couple together the fins 20 that are adjacent to each other, couple together the plurality of fins 20 in an integrated manner, and couple the fins 20 to the upper frame 13 and the lower frame 14 that constitute an outer frame of the bezel 12. In this way, the pillars 19 improve the strength of the fins 20 and the filter body 22.

As illustrated in FIG. 3, the filter device according to the embodiment described so far includes the filter body 22 and the bezel 12. The filter body 22 has the top sections 23 at its upstream end in the flow direction of the air that passes through the filter body 22. The bezel 12 includes the fins 20. In the flow direction of the air, the fins 20 are aligned with the top sections 23. The air that flows between two fins 20 that are adjacent to each other flows into the corresponding valley portion 26 of the filter body 22 and passes through the filter body 22.

In this way, it is possible to reduce the accumulation of dust between the mountain portions 25 of the filter body 22 and the fins 20 and between the mountain portions 25 that are adjacent to each other. If dust is accumulated, fine particles that can pass through the filter body 22 under ordinary circumstances are likely to adhere to the dust, so that clogging of the filter device is promoted. As a result, the flow of cooling air is disturbed, so that the efficiency of cooling the assembled battery 41 is reduced. However, when the filter device according to the present embodiment is employed, the accumulation of dust can be reduced. Thus, clogging of the filter device can be suppressed, so that the efficiency of cooling the assembled battery 41 can be improved. Because clogging of the filter device is suppressed, the maintenance interval for the filter device can be extended.

The filter body 22 is provided at a position considerably close to the bezel 12, and the valley portions 26, which serve as pathways for the air, are disposed between the fins 20 that are adjacent to each other. Thus, a worker can easily visually check the filter body 22 through spaces between the fins 20. Because the amount of dust accumulated in the filter body 22 can be visually checked easily, periodical cleaning of the filter device is promoted, and clogging of the filter device can be suppressed further effectively.

As illustrated in FIG. 3, the top sections 23 of the filter body 22 are fixed to the downstream ends of the fins 20. Because the filter body 22 and the fins 20 are integrally molded, assembly can be easily performed without taking the tolerances into account. In addition, because a space is no longer present between each of the fins 20 and the filter body 22, the accumulation of dust can be reduced further efficiently. Furthermore, because the filter body 22 and the fins 20 are integral with each other as a single-piece structure, the rigidity of the filter device can be improved. Thus, it is possible to avoid deformation of the filter body 22 when the filter device is cleaned.

While the example embodiment has been described so far, it is to be understood that the foregoing disclosure is to be considered in all respects as illustrative and not restrictive. The technical scope of the disclosure is defined by claims, and all changes which come within the meaning and range of equivalency of the claims are therefore intended to be embraced therein.

The filter device and the battery cooling apparatus described in this specification may be applied to, for example, vehicles and various kinds of equipment.

What is claimed is:

1. A filter device comprising:
a filter body folded in pleats, the filter body including top sections and bottom sections that are alternately aligned, and the filter body having the top sections at an upstream end of the filter body in a flow direction of gas that passes through the filter body; and
a bezel configured to support the filter body, the bezel including a fin provided upstream of the filter body in the flow direction of the gas,
wherein the fin and the top section are aligned with each other in the flow direction of the gas.

2. The filter device according to claim 1, wherein:
the bezel includes a frame, a plurality of the fins, and a plurality of pillars;
the frame includes an upper frame, a lower frame, and two lateral frames, the two lateral frames respectively coupling a first end portion of the upper frame and a second end portion of the upper frame to a first end portion of the lower frame and a second end portion of the lower frame;
the plurality of fins are provided parallel to each other; and
the plurality of pillars are provided parallel to each other and couple the upper frame to the lower frame.

3. The filter device according to claim 2, wherein the upper frame, the lower frame, and the two lateral frames of the frame form a parallelogram.

4. The filter device according to claim 2, wherein the fins intersect perpendicularly with the pillars within the frame.

5. The filter device according to claim 2, wherein the pillars extend in a direction perpendicular to an extending direction of the upper frame and the lower frame.

6. The filter device according to claim 1, wherein the top section is fixed to a downstream end of the fin.

7. A battery cooling apparatus comprising:
a battery;
a duct configured to guide cooling gas to the battery; and
the filter device according to claim 1, the filter device being attached to the duct, and the filter device being configured such that the cooling gas passes through the filter device.
